(19) United States
(12) Patent Application Publication
(10) Pub. No.: US 2009/0024925 A1
(43) Pub. Date: Jan. 22, 2009

(54) SYSTEM AND METHOD FOR CREATING AND DISTRIBUTING DERIVATIVE MEDIA WORK

(76) Inventor: Andrew Stevens, Dundas, MN (US)

Correspondence Address: SCHOX PLC, 730 Florida Street #2, San Francisco, CA, 94110, US

(21) Appl. No.: 12/176,080

(22) Filed: Jul. 18, 2008

Related U.S. Application Data
(60) Provisional application No. 60/950,543, filed on Jul. 18, 2007.

(51) Int. Cl. G06F 3/048

(52) U.S. Cl. 715/716

(57) ABSTRACT

A method of reproducing a derivative media work includes selecting a derivative media work derived from a first media work, locating an accessible source of the first media work, accessing a set of playback control instructions corresponding to the derivative media work, and reproducing the derivative media work by playing the accessible source of the first media work according to the playback control instructions. A method of creating and distributing a derivative media work includes creating playback control instructions to produce a derivative media work from a first accessible source of a media work on a first media player device, transmitting the created playback control instructions to a server, storing the received playback control instructions on the server, transmitting the created playback control instructions to a second media player device, and reproducing the derivative media work on the second media player device by playing a second accessible source of a media work according to the playback control instructions.

### CROSS-REFERENCE TO RELATED APPLICATIONS

This application claims the benefit of U.S. Provisional Application No. 60/950,543, filed 18 Jul. 2007, which is incorporated in its entirety by this reference.

### TECHNICAL FIELD

This invention relates generally to the field of media distribution, and more specifically to a new and useful system and method for creating and distributing derivative media works.

### BACKGROUND

With powerful personal computers and strongly interconnected networks, the original version of a copyrighted media work can be easily manipulated to create a derivative media work and can be easily distributed over the Internet or other distribution methods. The creation and distribution often occurs without any authorization by the original copyright holder, in violation of the copyright laws. The most infamous example of this is “The Phantom Edit” an edited version of “Star Wars: Episode 1” that was edited by an unknown author and distributed over the Internet and on physical mediums.

Thus, there is a need in the field of media distribution for a system and method that enables the creation and distribution of derivative media works based upon an original source media work while minimizing or eliminating copyright liability. This invention provides such a system and method.

### BRIEF DESCRIPTION OF THE FIGURES

FIG. 1 is a flowchart representation of a first preferred method of the invention.

FIG. 2 is a flowchart representation of a second preferred method of the invention.

FIG. 3 is a schematic representation of a preferred embodiment of the invention.

FIG. 4 is a flowchart representation of a third preferred method of the invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 0. General Description of the Preferred Embodiments

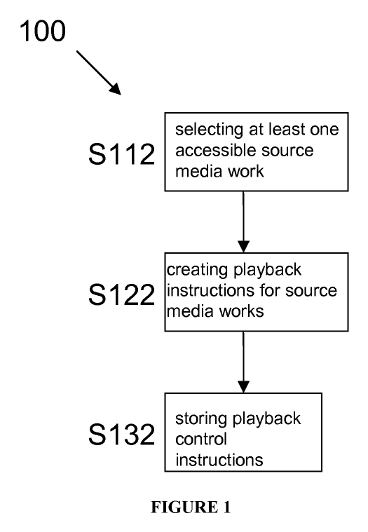

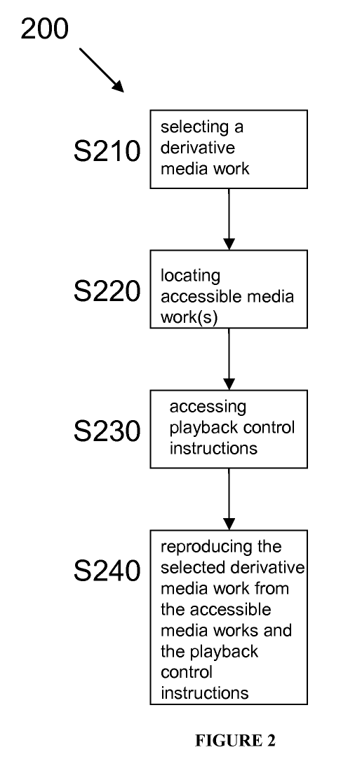

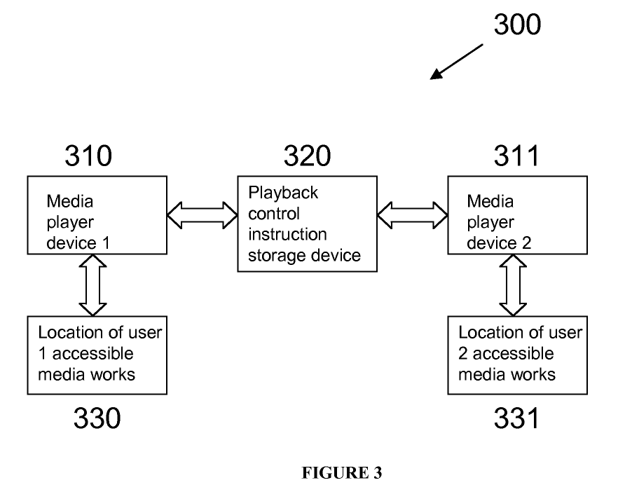

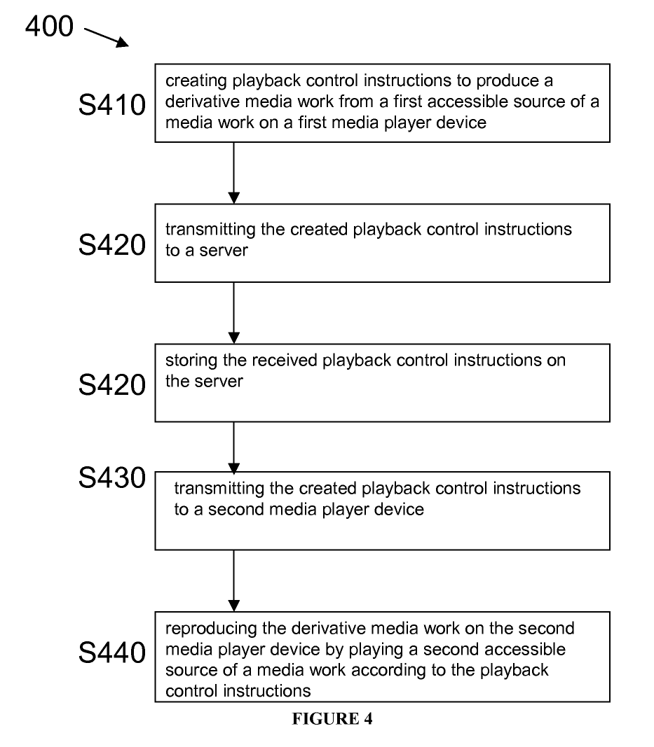

As shown in FIGS. 1-4, the preferred methods and system of the invention, which are used to create and reproduce derivative media works using playback control instructions to control the playback of user accessible source media works. The preferred method 100 of creating playback control instructions for source media works to reproduce derivative media works is shown in FIG. 1, and the preferred method 200 of reproducing derivative media works from source media works according to playback control instructions is shown in FIG. 2. A preferred embodiment of a system 300 for creating and distributing playback control instructions used to create derivative media works from source media works is shown in FIG. 3. A preferred method 400 of creating and distributing derivative media works is shown in FIG. 4.

### 1. Creating Playback Control Instructions to Create a Derivative Media Work

As shown in FIG. 1, the preferred method 100 of creating derivative media work includes (a) selecting at least one accessible source media work S112, (b) creating playback control instructions for said selected source media work(s) S122, and (c) storing said playback control instructions S132.

Step S112 functions to select the source media work(s) that will be used to create the derivative media works. The selection is preferably a user selection, but may be selected by a machine, decision rule, or any other selection method. The source media works are preferably selected from the user accessible media works, and may be located by an index or search, for example, if a user has access to a large media library, or a subscription service, such as those provided by Napster or Netflix. In one variation of step S112, access to additional source media works may be offered, preferably after a transaction, more preferably after a commercial transaction.

Step S122 functions to create at least one playback instruction for said selected accessible source media work(s). Step S122 preferably includes a component for reviewing and modifying the media playback control instructions. Preferably, the playback control instructions may be re-ordered or parallelized in step S122, new playback control instructions may be inserted, playback control instructions may be deleted, and playback control instruction properties may be altered, such as volume. In one variation, the step S122 allows the insertion of at least one playback control instruction from other derivative media works.

Step S132 functions to store the playback control instructions. Preferably, the playback control instructions are stored in a relational database, more preferably in a relational database on a server in a network. Preferably, the playback control instructions are generically applicable to the source media work, such that they may be distributed and applied to other accessible source media works, when combined with source media work location information. In one variation, the playback control instructions may be stored as a file, either locally or remotely.

2. Reproducing Derivative Media Works from Source Media Works

As shown in FIG. 2, the preferred method 200 of reproducing a derivative media work includes selecting a derivative media work S210, locating accessible media work(s) S220, accessing playback control instructions S230, reproducing the selected derivative media work from the accessible media works and the playback control instructions S240.

Step S210, which recites selecting a derivative media work functions to select a derivative media work to reproduce with accessible source media works. The derivative media work is preferably selected from a collection of derivative media works, more preferably the collection of derivative media works is derived from at least one media work. Preferably the collection of derivative media works is generated by accessing information about the derivative work, such as which media works are required for the reproduction of the derivative media work, such that a user may browse a selection of derivative media works that require at least one specific accessible source media work. The listing of a derivative media works preferably presents information about each derivative work, such as number of views, playback time, reviews, ratings, summaries, title, author, and/or any other information pertaining to the derivative work and/or source works. Preferably, step S210 also includes a function for sorting, searching, or filtering the derivative works according to user specified parameters. In one variation, the user may select any number of accessible media work(s), and a listing of all of the possible groups of playback control instructions that reproduce derivative works from those source media works are presented. In another variation of step S210, lists of derivative works that the user may partially reproduce from currently accessible works may be presented with references to commercial transactions to obtain access to additional source media works required to fully re-produce the derivative media works. In another variation of step S210, the selection of derivative media works may list all of the groups of playback control instructions that reproduce derivative media works and allow the user to browse these groups of playback control instructions, preferably providing references to transactions (more preferably commercial transactions) that allow the consumer to obtain all of the necessary source media works to view the derivative media works, as needed.

Step S220, which recites locating accessible media work(s), functions to locate an accessible source of a media work or acquire access to user accessible media works, such that derivative media works may be completely or partially played back. Step S220 is preferably performed via user specification of the location of media works accessible to the user, but may alternatively be assumed by the media player. Accessible media works may include media works the user already possesses or owns, media works that are accessible by a subscription service such as satellite TV, cable TV, Internet protocol TV, or Napster music subscription service, or video subscription services such as Netflix, Blockbuster, Amazon, iTunes, or any other suitable subscription service,. Accessible works may also include media works that may be rented or lawfully borrowed by the user, or any other media works the user may have lawful access to. Preferably, if a distribution channel exists, access to media works may be obtainable after a commercial transaction, permanent purchase, temporary lease or rental, fixed number of playbacks, pay per playback, pay per partial playback (e.g. only for the portions of the media work used for the derivative media work) or any other terms for accessing a source media work. The specification of the location of an accessible media work preferably includes specifying the path of a media file, inserting a media disk, specifying a web address, selecting a media stream from a media server, physically providing the media work, or providing any other location information that enables access to a media work. The user specified media work locations are preferably stored as a media work source specification, more preferably in an electronic database, and even more preferably identified as at least one of a user's accessible copies of a specific media work. In one variation, the user accessible media works may be located by an index or search, for example if a user had access to a large media library, or a subscription service, such as those provided by Napster or Netflix. One alternative variation includes verifying that a user has access to a certain media work. For example—a user has at least one copy of a media file or DVD of the film “The Matrix”, on which some operations are performed, such as hash function processing, filesize check, digital rights certificate check, filename check, unique identifier, DVD disk identifier, film length check, etc. and if the media work is recognized as valid, the media work may be accessed from an alternate source, such as streaming an online copy of the media work. In the preferred embodiment, step S220 may occur either before or after step S210.

Step S230 which recites accessing playback control instructions functions to access groups of playback control instructions that control the playback of the accessible media works to reproduce derivative media works, more preferably accessing a set of playback control instructions corresponding to the derivative media work. Preferably, the playback control instructions are streamed over the network from a server, more preferably with at least one of the next playback control instructions being fetched as at least one of previous playback control instructions are completed. In the preferred embodiment, the playback control instructions may be streamed over a network, more preferably as JavaScript instructions controlling at least one media player embedded in a web browser. In one variation, the playback protocol instructions are modified to include the locations or access information for accessible media works generated in Step S220, and the modified instructions for controlled playback of the user accessible media works are streamed to a client device to reproduce the media work. In another variation, the playback control instructions may be generated and/or modified in response to user input, such as selecting the preferred format, media player, operating system, mobile phone, video game system or other device. In another variation, the playback control instructions may be distributed in a file that the user downloads or accesses. In one alternative variation, Step S230 may include outputting the playback control instructions in one or more file formats, such as SMIL or a Microsoft Windows Media playlist format. In another alternative variation, Step S230 may include the insertion of playback control instructions for advertisements or other information into the group of playback control instructions for the derivative work, with the playback control instructions preferably inserted in real-time, but alternatively may be inserted by pre-processing the playback control instructions for a derivative media work.

Step S240, which recites reproducing the selected derivative media work from the accessible media works and the playback control instructions functions to reproduce the derivative media work by playing the accessible sources of media works according to the playback control instructions. The reproduced derivative media work is preferably output to an output device, but variations on step S240 may include recording or re-transmitting the media works for consumption in other circumstances, such as another time, or another location. In one such variation, a pre-processor processes and combines portions of the accessible source media works defined by the to playback control instructions to create a recording of the derivative media work. The playback control instructions may be processed in order, but alternatively may be processed out of order, or grouped by task for batch processing, or any other suitable instruction processing order.

### 3. System for Creating and Distributing Derivative Media Works

As shown in FIG. 3, a system for creating and distributing derivative media works 300, includes (a) at least one media player device 310, 311 (b) at least one playback control instruction storage device 320 (c) at least one specification of the location or access information for source media works 330, 331.

As shown in FIG. 3, the media player device 310, 311 functions to play back the located accessible source media works media according to the media playback control instructions that have been stored in the playback control instruction storage device 320. Preferably, if the media player device 310, 311 is used to create a new derivative media work, at least one user controls at least one media player device 310, 311 and preferably store the controlled playback as playback control instructions on the playback control instructions storage device 320. Preferably, if a media player device 310, 311 is used to play back a derivative media work, then the media player device 310, 311 accesses the playback control instructions on the playback control instruction storage device 320 to playback the source media works specified in the location(s) of the user accessible source media work(s). The media player device 310, 311 preferably includes a scripting control interface, more preferably a Javascript control interface. The media player device 310, 311 is preferably implemented as a computer software program, more preferably as a rich Internet application run from an Internet browser, or alternatively as a program created with the Adobe AIR (formerly codenamed Adobe Apollo) runtime for rich Internet applications. More preferably, the media player device 310, 311 is an Internet browser embedded media player with a scripting control interface, such as a Javascript control interface, for Windows Media Player, Apple Quicktime, DivX Webplayer, Adobe Flash player, Microsoft Silverlight player, or any other media player with any other scripting control interface. Alternative variations of the media player device 310, 311 may be implemented in computer hardware and/or software, such as in a Set-Top box, mobile communications device (e.g. Apple iphone, Blackberry), portable media player device, (Apple Ipod, Microsoft Zune), movie theater projector, or any other media player device.

As shown in FIG. 3, the playback control instruction storage device 320 preferably stores the playback control instructions generated by user-controlled playback of the media player device 310, 311. In the preferred embodiment, the playback control instruction storage device is preferably adapted to record playback control instructions corresponding to a derivative media work created from a first media player device accessing a first accessible source of a media work and the playback control instruction storage device is also preferably adapted to transmit playback control instructions corresponding to the derivative media work to a second media player device to reproduce the derivative media work by accessing a second accessible source of a media work according to the playback control instructions. The first accessible source and the second accessible source are preferably different copies of the same media work, but may alternatively be the same media work streamed from the same server, the same media work shared between media player devices, or the same media work in different formats (i.e. different video formats MPEG-4 vs. MPEG-2, resolutions, bitrates, framerates, etc.). In one variation substantially similar variations of a media work (e.g. different cuts of a movie, or different remixes of a song) may be used in place of a standard media work. Preferably, the playback control instructions are stored in a relational database, and more preferably associated with other metadata about the derivative media work, such as author, number of views, rating, length, etc. Preferably, a scripting language, more preferably Javascript, is used for the execution of the playback control instructions in the media player device, and preferably an AJAX (Asynchronous Javascript and XML) protocol is used for communications between the playback control instruction storage device 320 and the scripting control interface of the media player device 310, 311 during controlled playback of the source media works and/or creation of derivative media works. Preferably, the playback control instruction storage device 320 sends the playback control instructions independent of the location of the user-accessible media works. In one preferred embodiment, upon completion of one playback control instruction, the next playback control instruction is preferably fetched from the server by sending an AJAX request, more preferably before the playback control instruction is completed (i.e. 10 seconds from the end of the playback control instruction, a new instruction is fetched). In this variation, the playback control instructions may be cached and/or queued. Alternatively, the playback control instructions stored in the playback control instruction storage device 320 may be modified (or updated) with the location or access information of user accessible media works 330, 331 before the media player device 310, 311 processes the playback control instructions. In one variation, playback control instructions may also be stored and/or transmitted to a media player device 310, 311 as a playlist file, such as a Windows Media playlist file, or Apple Quicktime SMIL file.

As shown in FIG. 3, the location or access information for at least one user accessible media work 330, 331 functions to enable access to user accessible source media works, such that the media player device 310, 311 is able to reproduce derivative media works by playing back the user accessible source media works 330,331 according to the playback control instructions received from the playback control instruction storage device 320. The specification of the accessible source of a media work is preferably specified relative to the media player device that will be using the specification. Preferably, each user may store the specified location or access information for at least one user accessible source media work in a relational database, as the location or access information for that user's accessible source media work(s) (e.g. the user library). The user accessible media works are preferably accessed, preferably using the location information or other access information, to allow the media player to play the user accessible media works according to the playback control instructions for the media works. Alternatively, the user may specify the location or access information for at least one user accessible source media work or the source media works may be selected from a library of user accessible source media works. One variation of the location of the user accessible media works 330, 331 may modify the playback control instructions with the locations of the user accessible media source media works, preferably in the playback control instructions storage device 320, or alternatively in the media player device 310, 311 or any combination thereof. One alternative variation of the location of the user accessible media works 330, 331, may offer access to additional source media works, preferably after a transaction, more preferably a commercial transaction.

### 4. Method for Creating and Distributing Derivative Media Works

As shown in FIG. 4, a method 400 of creating and distributing a derivative media work includes creating playback control instructions to produce a derivative media work from a first accessible source of a media work on a first media player device S410, transmitting the created playback control instructions to a server S420, storing the received playback control instructions on the server S430, transmitting the created playback control instructions to a second media player device S440, and reproducing the derivative media work on the second media player device by playing a second accessible source of a media work according to the playback control instructions S450.

S410, which recites creating playback control instructions to produce a derivative media work functions to enable the recording of playback control instructions from a media player device playing at least one accessible source of a media work. The playback control instructions are preferably created by recording user activated controls during playback of a media work, and editing individual properties or arrangements of playback control instructions manually, but alternatively the playback control instructions may be manually created. Creating the playback control instructions preferably includes playing a media work from an accessible source of a media work, but may include manually creating the playback control instructions. Step S410 is preferably performed in a computer software program, more preferably as a rich Internet application run from an Internet browser, or alternatively as a program created with the Adobe AIR (formerly codenamed Adobe Apollo) runtime for rich Internet applications, but may alternatively be performed in a Set-Top box, mobile communications device (e.g. Apple iphone, Blackberry), portable media player device, (Apple Ipod, Microsoft Zune), movie theater projector, an Internet browser embedded media player with a scripting control interface, such as a Javascript control interface, for Windows Media Player, Apple Quicktime, DivX Webplayer, Adobe Flash player, Microsoft Silverlight player, or any other media player with any other scripting control interface.

S420 functions to transmit the created playback control instructions to a server. The created playback control instructions are preferably sent to the server as they are created and edited, but may alternatively be created as a set of playback control instructions on the media player device. The playback control instructions are preferably transmitted with an AJAX request, but may alternatively be transmitted via an HTTP request, and HTFP header, an HTFP POST form submission, or any suitable data transmission.

S430, functions to store the received playback control instructions on the server. The playback control instructions are preferably stored in a relational database, and are preferably recorded and updated as playback control instructions are received by the server. The playback control instructions are preferably associated with other metadata about the derivative media work, such as author, number of views, rating, length, etc. Preferably, a scripting language, more preferably Javascript, is used for the execution of the playback control instructions in a media player device, and an AJAX protocol is preferably used for communications between the server and a scripting control interface of the media player device during controlled playback of the source media works and/or creation of derivative media works. Alternatively, Step S430 may include modifying the stored playback control instructions stored with the location or access information of user accessible media works before transmitting the playback control instructions to the media player. In one variation, playback control instructions may also be stored as a playlist file, such as a Windows Media playlist file, or Apple Quicktime SMIL file.

S440, which recites transmitting the created playback control instructions to a second media player device functions to distribute the playback control instructions corresponding to the derivative media work to a second media player. Preferably, Step S440 includes sending the playback control instructions from the server independent of the location of the user-accessible media works. In one preferred variation, upon completion of one playback control instruction, the next playback control instruction is preferably sent from the server in response to an AJAX request, more preferably before the playback control instruction is completed (i.e. 10 seconds from the end of the playback control instruction), a new instruction is fetched. In this variation, the playback control instructions may be cached and/or queued. In one variation, playback control instructions may also be transmitted as a playlist file, such as a Windows Media playlist file, or Apple Quicktime SMIL file.

S450, which recites reproducing the derivative media work, functions to reproduce the derivative media work on the second media player device by playing a second accessible source of a media work according to the playback control instructions received from the server. The reproduced derivative media work is preferably output to an output device, but variations on step S450 may include recording or re-transmitting the media works for consumption in other circumstances, such as another time, or another location. In one such variation, a pre-processor processes and combines portions of the accessible source media works defined by the to playback control instructions to create a recording of the derivative media work. The playback control instructions may be processed in order, but alternatively may be processed out of order, or grouped by task for batch processing, or any other suitable instruction processing order.

### 4. Description of Playback Control Instructions

The playback control instructions preferably do not contain any portion of the media work, in an effort to avoid using any material that may be protected under copyright law, such as video, audio, text, etc. However, the group of instructions may be considered an independent work that may be protected under copyright. The playback control instructions preferably include time or frame points in the content, references to source media works, and any number of actions that may include play, stop, subtitle insertion, audio track manipulations, insertion of other information, media or advertisements (in sequence or simultaneously), volume changes, brightness changes, picture changes, partial picture manipulations, time delay, time direction (such as playing backwards), speed of playback, and priority of clips, quality of service, and any other instructions that control the playback. The playback control instructions may be executed in a pre-defined sequence, in parallel, a randomized shuffle mode, or any combination thereof. The playback control instructions may be distributed to anyone who has the ability to access at least one of the source media works and to enable the reproduction of the derivative media work without violating copyright.

As a person skilled in the art will recognize from the previous detailed description and from the figures and claims, modifications and changes can be made to the preferred embodiments of the invention without departing from the scope of this invention defined in the following claims.

I claim:

1. A method of reproducing a derivative media work, comprising:
selecting a derivative media work derived from a first media work;
locating an accessible source of the first media work;
accessing a set of playback control instructions corresponding to the derivative media work; and
reproducing the derivative media work by playing the accessible source of the first media work according to the playback control instructions.

2. The method of claim 1, wherein the step of selecting a derivative media work includes selecting a derivative media work derived from a first media work and a second media work, and further comprising the step of locating an accessible source of the second media work, and wherein the step of reproducing the derivative media work includes playing the accessible source of the first media work and the second media work according to the playback control instructions.

3. The method of claim 1, further comprising the step of caching the reproduced derivative media work for playback at a later time.

4. The method of claim 1, wherein the accessible source of the first media work is selected from a media library including a plurality of media works.

5. The method of claim 4, wherein the media library includes a plurality of media works possessed by a user.

6. The method of claim 4, wherein the media library includes a plurality of media works available to a user in an online library.

7. The method of claim 6, wherein the online library is accessible to the user after a commercial transaction.

8. The method of claim 6, wherein the media works accessible by the user via a subscription are streamed over a network.

9. The method of claim 4, further comprising the step of listing a plurality of derivative media works, wherein each derivative media work in the plurality of derivative media works is derived from one or more media works in the plurality of media works.

10. The method of claim 9, wherein the plurality of derivative media works includes completely reproducible derivative media works and partially reproducible derivative media works.

11. The method of claim 10, wherein each listed partially reproducible derivative media work includes a listing of additional media works required to completely reproduce each partially reproducible derivative media work.

12. The method of claim 11, wherein the listing of additional media works includes a reference to a commercial transaction to acquire access to an additional media work.

13. A method of creating and distributing a derivative media work, comprising:
creating playback control instructions to produce a derivative media work from a first accessible source of a media work on a first media player device;
transmitting the created playback control instructions to a server;
storing the received playback control instructions on the server;
transmitting the created playback control instructions to a second media player device; and
reproducing the derivative media work on the second media player device by playing a second accessible source of a media work according to the playback control instructions.

14. The method of claim 13, wherein the first accessible source of a media work is in a first format and the second accessible source of a media work is in a second format.

15. The method of claim 13, wherein the step of reproducing the derivative media work on the second media player device by playing a second accessible source of a media work according to the playback control instructions includes streaming the playback control instructions during the reproduction of the derivative media work.

16. The method of claim 13, wherein the step of creating playback control instructions to produce a derivative media work includes creating playback control instructions to produce a derivative media work from a first accessible source of a first media work and from a first accessible source of a second media work on a first media player device.

17. The method of claim 16, wherein the step of reproducing the derivative media work includes reproducing the derivative media work on the second media player device by playing a second accessible source of a first media work and a second accessible source of a second media work according to the playback control instructions.

18. A system for creating and distributing a derivative media work comprising:
a first media player device;
a second media player device;
a specification of a first accessible source of a media work relative to the first media player device;
a specification of a second accessible source of a media work relative to the second media player device; and
a playback control instruction storage device adapted to record playback control instructions corresponding to a derivative media work created from the first media player device accessing the first accessible source of a media work and transmit playback control instructions corresponding to the derivative media work to the second media player device to reproduce the derivative media work by accessing the second accessible source of a media work according to the playback control instructions.

19. The system of claim 19, wherein the first accessible source of a media work is in a first format and the second accessible source of a media work is in a second format.

20. The system of claim 19, wherein the second media player device streams the playback control instructions from the playback control instruction storage device during the reproduction of the derivative media work.
